(19) United States
(12) Patent Application Publication
(10) Pub. No.: US 2025/0295128 A1
(43) Pub. Date: Sep. 25, 2025

(54) APPARATUS FOR MINCING A PRODUCT TO BE MINCED

(71) Applicant: Inotec GmbH Maschinenentwicklung Und Vertrieb, Reutlingen (DE)

(72) Inventor: Miroslav Domlatil, Reutlingen (DE)

(73) Assignee: Inotec GmbH Maschinenentwicklung Und Vertrieb, Reutlingen (DE)

(21) Appl. No.: 18/861,727

(22) PCT Filed: May 11, 2023
(86) PCT No.: PCT/EP2023/062554

§ 371 Date: Oct. 30, 2024

(30) Foreign Application Priority Data
May 11, 2022 (DE) 10 2022 111 847.9

(51) Int. Cl. A22C 17/00; B02C 18/30

(52) U.S. Cl. CPC A22C 17/0026; B02C 18/305; B02C 2018/308

(57) ABSTRACT

An apparatus for mincing a product to be minced, particularly for the meat-processing industry, includes at least one fixed perforated plate (7) and a cutting element (10, 25) rotating in front of said perforated plate and connected for conjoint rotation to a shaft (6), which are accommodated in a cutting housing (2), a retaining finger ring (9), which is axially displaceable in the direction of the shaft (6), and arranged between the cutting housing (2), the fixed perforated plate (7) and the rotating cutting element (10, 25).

### TECHNICAL FIELD

The invention concerns an apparatus for mincing a product to be minced, particularly for the meat-processing industry, having at least one fixed perforated plate and a cutting element rotating in front of said perforated plate and connected for conjoint rotation to a shaft, which are accommodated in a cutting housing.

### PRIOR ART

Apparatuses of this type are commercially available and known in a variety of forms and configurations and are also referred to as grinders. A key component in each case is the cutting device, which can come in various forms and meets diverse requirements. Thus, for example, WO 00 2012 095 083 A1 presents a cutting system comprising static and rotating perforated plates. Here a spacer ring provided in a central guide bore of a stationary perforated plate is rotatably arranged on a main axis for co-rotation with the cutting perforated plates and, by reason of its thickness, especially where a plurality of cutting sets are provided, determines the axial spacing between the rotating cutting perforated plate and the next rotating cutting perforated plate in the conveying direction. It is possible in this way to keep the spacing between all cutting perforated plates and the associated perforated plate so small that it gives rise to a conveying effect in the manner of a water jet pump. A spacing of 0.02 mm to 0.04 mm is possible. The stationary and the rotating perforated plates are thus almost touching and are separated only by a very thin lubricating film, which is formed by the product itself. By contrast, however, if the product contains bones, is very sinewy or hard, for example, such as rinds, then the spacing between the perforated plates is too small. There is thus only limited scope for a lubricating film to form. This leads to considerable wear on the first perforated plates, however, since these in particular have to intercept the hard particles. Once the cutting tools have become worn, they have to be reground. However, this means that if the rotating perforated plates are reground and are less thick, then with this construction the spacer rings also have to be reground at the same time. Considerable expenditure is then required to maintain the precision of the spacer rings. The customer is not generally in a position to regrind the corresponding cutting tools.

Cutting sets consisting of static perforated plates and rotating cutting blades/cutting heads are described in EP 1 237 656 B1. In this cutting set, the spacing between the perforated plates and the cutting blades is adjustable. A gap between the perforated plates and the cutting blades is increased when the drive for the cutting head is shut off (waiting position) and reduced when the drive is started up (working position=shearing position). The wear costs for the cutting sets are relatively low, since the wear parts/cutting blades are replaced when they are worn and the perforated plates can be reground. Regrinding of the perforated plates is inexpensive because there is no need to adhere to precise perforated plate thicknesses including tolerances. This means that a customer can regrind the perforated plates in house.

A cutting set consisting of static and rotating perforated plates is described in EP 2 987 557 B1. The stationary and rotating perforated plates are almost touching, in the order of magnitude of one or more thousandths of a millimetre, and are separated only by a very thin lubricating film, which is formed by the product itself. A stationary perforated plate and a cutter head are positioned in front of the whole arrangement. The gap between the first stationary perforated plate and the cutter head is adjustable. In this process, the shaft on which the rotating perforated plate is positioned is moved axially. The axial adjustment can be made using a handwheel, for example. If a spacing needs to be adjusted in a reproducible manner, however, a servomotor is required for the axial movement. At the very high cutting forces that occur, particularly when processing product that contains bones or is very sinewy or hard, there is a considerable risk that this servomotor will not function adequately. Furthermore, the spacing between the perforated plates is too small, so in this case too there is only limited scope for a lubricating film to form, and this in turn leads to dry running and substantial wear, especially at the first perforated plate, which has to intercept hard particles.

### SUMMARY OF THE INVENTION

The problem addressed by the present invention is that of developing an apparatus of the aforementioned type which is also suitable for products that contain bones or are very sinewy or hard, which functions in a stable manner and guarantees a desired product quality in a reproducible manner. At the same time, the wear on the cutting elements should be significantly reduced.

The problem is solved by the arrangement of a retaining finger ring, which is axially displaceable in the direction of the shaft, between the cutting housing, the fixed perforated plate and the rotating cutting element.

This means that when the apparatus according to the invention is assembled, the spacing between a stationary perforated plate and a rotating cutting element, whether it be a perforated plate or a cutter head with cutting blades, is always the same, regardless of any wear to the surface of the perforated plate or the thickness of the cutting blades. There is only one working position, which is kept constant. When the equipment is in operation, there is no possibility for adjusting an axial spacing between the stationary perforated plate and the rotating perforated plate or the cutter head because such a spacing is not desirable.

It is known that the apparatus according to the invention very often has to be disassembled after use, cleaned, and reassembled for reuse. Correspondingly strict hygiene rules have to be observed in this process. The present invention has the crucial advantage that when the perforated plates or the perforated plates and the cutter heads are assembled for reuse, any wear of the cutting elements or of the surfaces of the perforated plates can be tracked. To this end, the retaining finger ring enables the fixed perforated plate to be moved correspondingly closer to the rotating perforated plate or the cutter head and then fixed in position again. With this pre-tensioning it is possible to carry on production for a day without the need for any further adjustment. Afterwards the apparatus is dismantled again and cleaned, and the next time it is assembled the gap between the perforated plates or between the perforated plate and the cutting blades of the cutter head is reduced to 0 again, even though the spacing has changed in relative terms due to the wear. This wear is compensated by the fact that the front face of the retaining finger ring is resiliently supported against the cutting housing or a separate infeed housing. This is achieved by means of a bolt, for example, which is spring-mounted in a blind hole in the retaining finger ring.

In a preferred exemplary embodiment, the stationary perforated plate should be supported against a shoulder in the retaining finger ring opposite the resilient support. The entire assembly is thus clamped around the rotating cutting element.

In a further exemplary embodiment of the invention it can be provided that a pre-cutter or additional cutter head, which is likewise mounted on the shaft for conjoint rotation, is positioned upstream of the rotating cutting element. The primary effect of this is to push product towards the first rotating perforated plate or to the subsequent cutter head.

A further exemplary embodiment of the invention envisages the use of not just one cutting set, comprising, for example, a fixed and a rotating perforated plate or a fixed perforated plate and a rotating cutter head with cutting blades, but rather of additional subsequent cutting sets. Each of these preferably consists of a pair of fixed and rotating perforated plates, which in turn are arranged in a separate ring, wherein this ring is also z-shaped. A shoulder is thus provided for the fixed perforated plate. A finger reaches over the rotating cutting element and presses against the subsequent fixed perforated plate, bracing it against its shoulder.

Protection is also sought as a whole for a method for producing the apparatus described above. This method involves first inserting the retaining finger ring into the cutting housing and then pushing the rotating cutting element onto the shaft. This is followed by insertion of the fixed perforated plate so that it rests in the shoulder of the retaining finger ring.

The entire unit is then braced against the cutting housing by means of a separate clamping ring so that the fixed cutting plate is also braced against the rotating cutting element and against the force of the resilient support. The method for inserting the subsequent pairs of cutting sets is carried out in a similar manner.

### BRIEF DESCRIPTION OF THE FIGURES

Further advantages, features and details of the invention can be obtained from the following description of preferred exemplary embodiments and from the drawings. In the drawings:

FIG. 1 shows a partial longitudinal section through an apparatus according to the invention for mincing a product to be minced;

FIG. 2 shows an enlargement of detail B from the apparatus in accordance with FIG. 1;

FIG. 3 shows a perspective view of a pre-cutter;

FIG. 4 shows an enlargement of a detail from FIG. 1 with inserted pre-cutter according to FIG. 3;

FIG. 5 shows a partial longitudinal section through the apparatus in accordance with FIG. 1 during assembly;

FIG. 6 shows an enlargement of detail D from the longitudinal section through the apparatus according to the invention in accordance with FIG. 5;

FIG. 7 shows a partial longitudinal section through a further exemplary embodiment of an apparatus according to the invention for mincing a product to be minced;

FIG. 8 shows a partial longitudinal section through the apparatus in accordance with FIG. 7 during assembly;

FIG. 9 shows an enlargement of detail C from FIG. 7 during assembly;

FIG. 10 shows an enlargement of detail C from FIG. 7 during assembly, taking account of wear to cutting blades.

### DETAILED DESCRIPTION

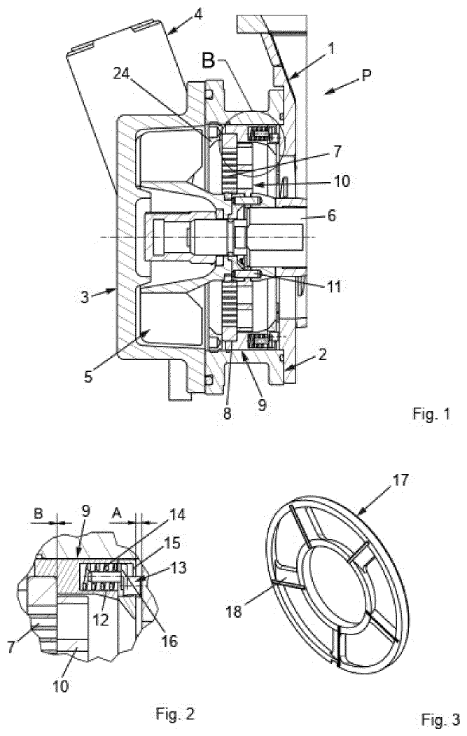

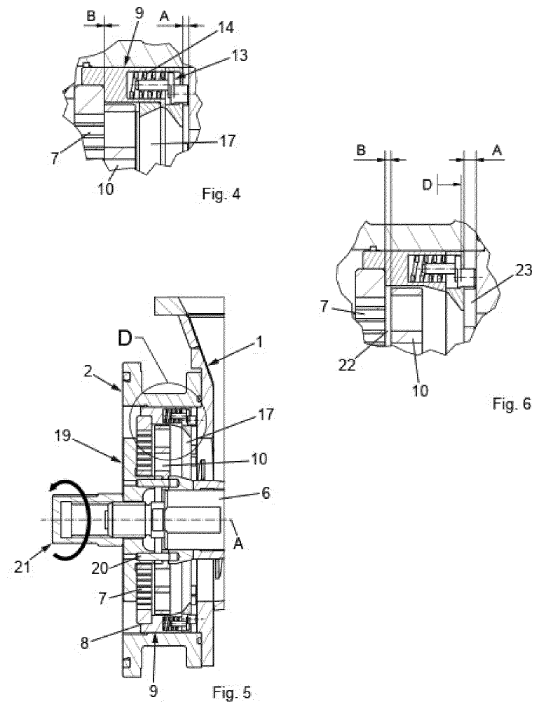

According to FIG. 1, an apparatus P according to the invention for mincing a product to be minced has an infeed housing 1 for the product to be minced, to which is attached a cutting housing 2. The cutting housing 2 is followed by an outlet housing 3 having an outlet pipe 4. The outlet housing 3 contains an ejector 5, which is mounted for conjoint rotation on the end of a shaft 6 that is connected to a drive (not shown).

A fixed perforated plate 7, which is inserted circumferentially in a shoulder 8 of a retaining finger ring 9, is attached to the ejector 5. This retaining finger ring 9 is slidably seated in the cutting housing 2 and encloses a rotating cutting element 10, which in the exemplary embodiment shown is likewise in the form of a perforated plate but can also be any type of cutting head. This rotating cutting element 10 is seated for conjoint rotation on the shaft 6, to which it is connected by means of studs 11.

On the periphery of the retaining finger ring 9 there are blind holes 12, each of which contains an eccentric bolt 13, which is supported in the blind hole 12 against a helical spring 14. The eccentric bolt 13 is secured by means of an annular collar 15, which is part of the retaining finger ring 9 and which reaches partly over the blind hole 12, so that a head 16 of the eccentric bolt 13 strikes the annular collar 15 from the inside.

If necessary, a pre-cutter 17 shown in FIG. 3 can also be positioned in front of the rotating cutting element 10 inside the retaining finger ring 9; this pre-cutter does not rotate with the shaft 6 but instead causes the product to accumulate, for example, and above all pre-cuts even a sinewy or hard product. This pre-cutter 17 is equipped with corresponding cutting edges 18.

The assembly according to the invention of the apparatus for mincing a product to be minced is described in more detail by reference to FIGS. 5 and 6:

After assembling the cutting housing 2 and infeed housing 1, the retaining finger ring 9 is inserted, wherein it slides into the cutting housing 2 until it strikes the infeed housing 1 with the bolt 13. Then the rotating cutting element 10 and the pre-cutter 17 if required are inserted into the retaining finger ring 9, and the fixed perforated plate 7 is introduced into the shoulder 8 of the retaining finger ring 9. A separate clamping disc 19, which is centred by pins 20, is then placed onto the end of the shaft and pressed against the perforated plate 7 by means of a nut 21. This gives rise to an axial displacement of the perforated plate 7 along a shaft axis A, wherein this perforated plate 7 takes the retaining finger ring 9 along with it. This continues until the width B of a gap 22 shown in FIG. 6 between the fixed perforated plate 7 and the rotating perforated plate 10 is reduced to 0. A corresponding compensation of the distance 23 between the retaining finger ring 9 and the infeed housing 1 is achieved by reducing the spacing A of this distance 23. The final position is shown in FIG. 2, where it can be seen that the width of the gap 22 has been reduced to 0. The whole assembly is secured by means of a clamping ring or threaded ring 24 (FIG. 1), which is screwed into the cutting housing 2 and presses against the perforated plate 7.

The clamping disc 19 and the nut 21 can now be removed and replaced by the ejector 5, which is joined to the shaft 6. The outlet housing 3 is then placed over the ejector 5 onto the cutting housing 2.

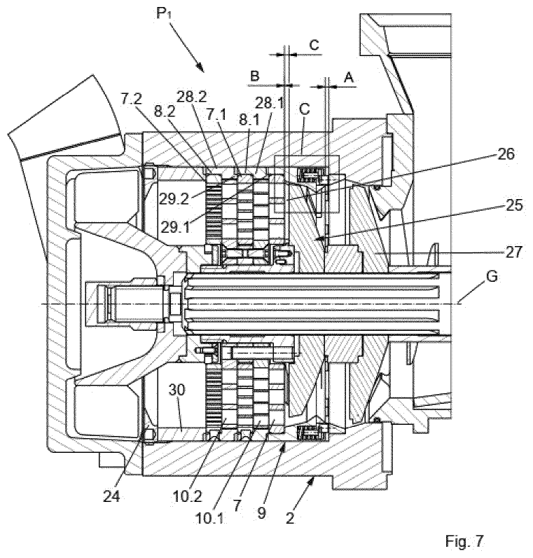

In a further exemplary embodiment of the apparatus P1 for mincing a product to be minced according to FIG. 7, a cutter head 25, the cutting blades 26 of which skim over the fixed perforated plate 7, is inserted into the retaining finger ring 9 in place of the rotating cutting plate 10. Furthermore, a displacement head 27 is positioned in front of this cutter head 25, the purpose of which is solely to convey the product in the axial direction or towards the shaft axis G.

In addition, the fixed perforated plate 7 is followed by two pairs of plates, each comprising a rotating perforated plate 10.1 and 10.2 and a fixed perforated plate 7.1 and 7.2. Each pair sits in a z-shaped ring 28.1 and 28.2 respectively, which are likewise slidably arranged in the cutting housing 2. The spacing between the perforated plates is in the 1/10 range, preferably from 20 to 25/100.

The z-shaped configuration means that each ring 28.1 and 28.2 has a shoulder 8.1 and 8.2 for the fixed cutting element 7.1 and 7.2, wherein an advancing finger 29.1 and 29.2 of the ring 28.1 and 28.2 presses on a fixed perforated plate 7 and 7.1 ahead of it. A spacer ring 30 is inserted onto the last fixed perforated plate 7.2 between the threaded ring 24.

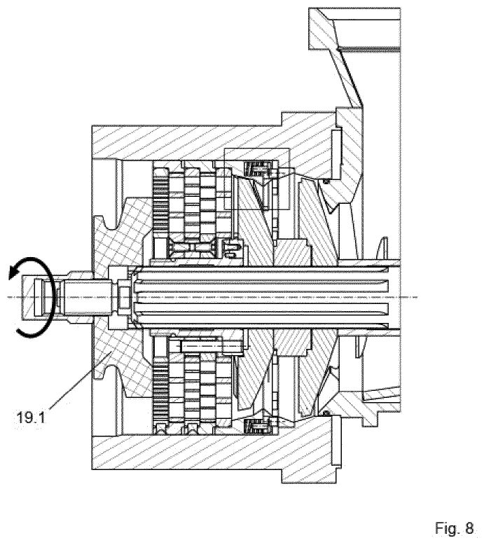

The apparatus according to the invention is assembled in the manner described above, so reference is made in this instance only to the drawing according to FIG. 8, since only the configuration of the clamping disc 19.1 is different.

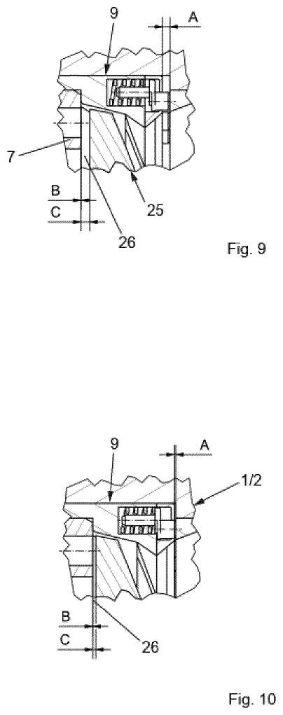

It can be seen from FIG. 9 that in this exemplary embodiment too, a gap between the fixed perforated plate 7 and a cutting blade 26 of the cutter head 25 is reduced to 0. However, if the thickness C of the cutting blade 26 decreases due to wear, as shown in FIG. 10, this wear can in turn be tracked by reducing the spacing A between the retaining finger ring 9 and the cutting housing 2 or infeed housing 1, so that in this case too the width 22 is ultimately equal to 0.

In a further preferred exemplary embodiment, the spacing between the rotating and stationary perforated plates, which, as mentioned above, is in the 1/10 range, is increased somewhat to reduce the wear. However, since this is not sufficient on its own, and dry running can still sometimes occur, a wear-resistant sliding layer is formed according to the invention between the perforated plates, which prevents this dry running. It has proved advisable in this connection to provide the rotating perforated plates 10.1 and 10.2 with a very hard sliding layer which is highly wear-resistant. The stationary perforated plate 7.1 receives a special grinding treatment, while the stationary perforated plates 7 and 7.2 are reground.

Improvements have also been made with regard to the diameters of the holes. If the diameter of the holes in the first stationary perforated plate 7 is smaller than that in the subsequent rotating perforated plate 10, this leads to blockages and hence to dry running. For that reason, the largest diameter is always chosen for the holes in the rotating perforated plate 10.

To optimise the product flow even in the case of multiple cutting sets, it has proved advantageous for the diameter of the holes in the rotating perforated plate 10.2 to be larger than the diameter in the preceding rotating perforated plate 10.1. This enables the product to decompress rearwards better and to emulsify better. For example, in the arrangement with five successive perforated plates, the diameter sequence is 10 mm-7 mm-5 mm-10 mm-2 mm.

The present exemplary embodiments show a 2-plate machine and a 5-plate machine. A 3-plate machine is also possible, of course, for example by removing the two perforated plates 7.2 and 10.2 and the ring 28.2 and by widening the spacer ring 30.

List of reference signs

| | |
|---|---|
| 1 | Infeed housing |
| 2 | Cutting housing |
| 3 | Outlet housing |
| 4 | Outlet pipe |
| 5 | Ejector |
| 6 | Shaft |
| 7 | Perforated plate |
| 8 | Shoulder |
| 9 | Retaining finger ring |
| 10 | Rotating cutting element |
| 11 | Studs |
| 12 | Blind hole |
| 13 | Eccentric bolt |
| 14 | Helical spring |
| 15 | Annular collar |
| 16 | Head |
| 17 | Pre-cutter |
| 18 | Cutting edge |
| 19 | Clamping disc |
| 20 | Pins |
| 21 | Nut |
| 22 | Gap |
| 23 | Distance |
| 24 | Threaded ring |
| 25 | Cutter head |
| 26 | Cutting blade |
| 27 | Displacement head |
| 28 | Ring |
| 29 | Pressure finger |
| 30 | Spacer ring |
| 31 | |
| 32 | |
| 33 | |
| 34 | |
| 35 | |
| 36 | |
| 37 | |
| 38 | |
| 39 | |
| 40 | |
| 41 | |
| 42 | |
| 43 | |
| 44 | |
| 45 | |
| 46 | |
| 47 | |
| 48 | |
| 49 | |
| 50 | |
| 51 | |
| 52 | |
| 53 | |
| 54 | |
| 55 | |
| 56 | |
| 57 | |
| 58 | |
| 59 | |
| 60 | |
| 61 | |
| 62 | |
| 63 | |
| 64 | |
| 65 | |
| 66 | |
| A | Spacing |
| B | Width of 22 |
| C | Thickness of 26 |
| G | Shaft axis |
| P | Apparatus |

1. An apparatus for mincing a product to be minced, particularly for the meat-processing industry, having at least one fixed perforated plate (7), in front of which a cutting element (10, 25) rotates, which is non-rotatably connected to a shaft (6), which are accommodated in a cutting housing (2),
wherein
a retaining finger ring (9), which is axially displaceable in the direction of the shaft (6), is arranged between the cutting housing (2), the fixed perforated plate (7) and the rotating cutting element (10, 25).

2. The apparatus according to claim 1, wherein the front face of the retaining finger ring (9) is resiliently supported against the cutting housing (2) or a separate infeed housing (1).

3. The apparatus according to claim 2, wherein the support is provided by at least one bolt (13).

4. The apparatus according to claim 2, wherein the resilient support is provided against at least one spring (14), which is arranged in the retaining finger ring (9).

5. The apparatus according to claim 1, wherein the stationary perforated plate (7) is supported against a shoulder (8) in the retaining finger ring (9).

6. The apparatus according to claim 5, wherein the shoulder (8) in the retaining finger ring (9) is provided opposite the resilient support.

7. The apparatus according to claim 1, wherein the cutting element is a rotating cutting plate (10).

8. The apparatus according to claim 1, wherein a pre-cutter (17) or additional displacement head (27), which is likewise mounted on the shaft (6) for conjoint rotation, is positioned upstream of the rotating cutting element (10).

9. The apparatus according to claim 1, wherein the fixed perforated plate (7) is followed beyond the rotating cutting element (10, 25) by further rotating perforated plates (10.1, 10.2) between fixed perforated plates (7.1, 7.2).

10. The apparatus according to claim 9, wherein the subsequent fixed and rotating perforated plates (10.1, 7.2; 701, 7.2) are each arranged in a ring (28.1, 28.2).

11. The apparatus according to claim 10, wherein the ring (28.1, 2) is z-shaped in cross-section, such that it offers a shoulder (8.1, 8.2) for a fixed perforated plate (7.1, 7.2) and presses on the subsequent fixed perforated plate (7.1, 7.2) with a pressure finger (29.1, 29.2).

12. The apparatus according to claim 1, wherein after the fixed perforated plate or the last fixed perforated plate (7, 7.2) in the cutting housing (2) there is a threaded ring (24), which can be screwed into the cutting housing (2).

13. A method for producing an apparatus for mincing a product to be minced, particularly for the meat-processing industry, having at least one fixed perforated plate (7), in front of which a cutting element (10, 25) rotates, which is non-rotatably connected to a shaft (6), which are accommodated in a cutting housing (2), wherein the fixed perforated plate (7) and the rotating cutting element (10) are arranged in a retaining finger ring (9) which when assembled is resiliently supported against the cutting housing (2) or a separate infeed housing (1) with an adjustable spacing A in the axial direction of the shaft and in this way permits a gap (22) between the fixed perforated plate (7) and the rotating cutting element (10) to be reduced to 0.

14. The method according to claim 13, wherein pairs of additional rotating and fixed perforated plates (10.1, 10.2 and 7.1, 7.2) are inserted after the first fixed perforated plate (7) and are surrounded by a ring (28.1, 28.2), which presses in each case against the subsequent fixed perforated plate (10, 10.1) in such a way that a gap (22) between the fixed and rotating perforated plate is reduced to 0.
